(19) United States
(12) Patent Application Publication
(10) Pub. No.: US 2025/0364766 A1
(43) Pub. Date: Nov. 27, 2025

(54) METHOD AND FACILITY FOR NANOSECOND LASER SPATIAL-TEMPORAL CONTROL IN A DIRECT-DRIVE LASER FACILITY WITH DOUBLE-CONE IGNITION SCHEME

(71) Applicant: Shanghai Institute of Optics and Fine Mechanics, Chinese Academy of Sciences, Shanghai (CN)

(72) Inventors: Wei FAN, Shanghai (CN); Yujia ZHANG, Shanghai (CN); Mingying SUN, Shanghai (CN); Xinghua LU, Shanghai (CN); Jiangfeng WANG, Shanghai (CN); Xiaochao WANG, Shanghai (CN); Yanli ZHANG, Shanghai (CN); Xiuqing JIANG, Shanghai (CN); Zhanfeng QIAO, Shanghai (CN)

(21) Appl. No.: 19/291,496

(22) Filed: Aug. 5, 2025

Related U.S. Application Data
(63) Continuation of application No. PCT/CN2024/131568, filed on Nov. 12, 2024.

(30) Foreign Application Priority Data
Jan. 30, 2024 (CN) 202410125596.1

(51) Int. Cl. H01S 3/00; H01S 3/10; H01S 3/109; H01S 3/23

(52) U.S. Cl. CPC H01S 3/0057; H01S 3/10053; H01S 3/10061; H01S 3/10092; H01S 3/109; H01S 3/2308; H01S 3/2391

(57) ABSTRACT

A nanosecond laser spatial-temporal control method for a direct-drive laser facility based on Double-Cone Ignition, while satisfying the near-isentropic compression waveform required for driving implosion, redistributes the temporal waveforms of all sub-beams in the facility. A small portion of the beams are used to generate a low-energy foot pulse, which is focused on a larger target surface. Under the action of the low-energy foot pulse, the target surface contracts slowly inward. By the end of the duration of the low-energy foot pulse, the target surface has contracted to a smaller size. At this moment, the remaining majority of the beams are used to generate the main drive pulse, which is focused on this smaller target surface, thereby achieving zooming.

### CROSS-REFERENCE TO RELATED APPLICATIONS

The subject application is a continuation of PCT/CN2024/131568 filed on Nov. 12, 2024, which in turn claims priority on Chinese Patent Application No. CN202410125596.1 filed on Jan. 30, 2024 in China. The contents and subject matter of the PCT international application and the Chinese priority application are incorporated herein by reference in the entirety.

### TECHNICAL FIELD

The present invention relates to cross-beam energy transfer (CBET) and target irradiation uniformity in laser-direct-drive inertial confinement fusion (ICF) facilities, and specifically a nanosecond laser spatial-temporal control method and facility based on Double-Cone Ignition direct-drive scheme.

### BACKGROUND OF INVENTION

Inertial Confinement Fusion (ICF) driven by lasers commonly employs two types of driving methods: direct drive and indirect drive. Indirect drive refers to a process where the laser does not directly irradiate the target capsule. Instead, it irradiates the walls of a hohlraum, generating X-rays which are then used to heat and compress the target capsule. The advantage of indirect drive is that the radiation source for driving the ablation is more uniform. However, the process of generating X-rays inevitably leads to energy losses, which in turn increases the demand for higher laser energy. Moreover, the Laser-Plasma Interactions (LPI) within the hohlraum are relatively complex. Direct drive, on the other hand, requires multiple beams to uniformly irradiate the target capsule which contains cryogenic nuclear fuel. The energy coupling efficiency of direct drive, where the driving laser energy is transferred to the deuterium-tritium (DT) fuel, is approximately 5 to 6 times higher than that of indirect drive. However, direct drive demands much higher degree of uniformity in laser beam irradiation. Research indicates that direct drive requires the irradiation uniformity on the surface of the target capsule to be within 1%. Direct drive can effectively convert laser energy into the kinetic energy of the target shell, compressing and gathering the fusion fuel to high densities, thereby meeting the conditions for thermonuclear ignition. (ρR≥0.3 g/cm², in this context, ρ represents the mass density of the fuel, and R represents the radius of the target capsule.)

In direct-drive ignition designs, the laser beam spot size is close to the target focal spot diameter. Cross-beam energy transfer (CBET) between multiple beams can lead to energy losses. CBET is a type of laser-plasma instability that essentially results from the overlap of multiple beams, causing in a significant energy transfer via diffraction on the ion acoustic wave gratings in the overlapping regions. It directly affects the uniform compression of the target in ICF, impacts the laser-target coupling efficiency, and thereby reduces the fusion yield. Research has shown that reducing the spot size can compensate for the kinetic energy lost due to CBET. However, the reduction simultaneously increases low-order mode perturbations and reduces irradiation uniformity, affecting implosion performance. Dual-state focal zooming can mitigate both CBET and low-order mode perturbations, leading to a more stable implosion process.

The traditional direct-drive configuration on OMEGA requires 60 beams to uniformly irradiate the entire spherical surface with a diameter of approximately 850 μm. The power balance requires that the root-mean-square (RMS) power imbalance be less than 1% in any 100-ps pulse interval. Therefore, OMEGA has extremely high requirements for pulse temporal synchronization, control precision of the temporal-power profile of each beam, and consistency of the temporal-power profiles among multiple beams. To reduce the impact of CBET, the OMEGA facility can only employ a two-step focal zooming scheme based on spatial-division multiplexing, which involves using time-varying wave-front and zooming phase plates (ZPP) to superimpose different phase structures on the beams at different moments, ultimately achieving a far-field focal spot size that varies with time. The zooming scheme based on spatial-division multiplexed can effectively overcome energy losses and CBET effects, but it has several major issues:

First, OMEGA uses ring-shaped beams to generate the main drive pulse, which requires a high requirement for the incident light field distribution. Second, the energy utilization rate of the incident beams is relatively low, with a maximum of only 75%. Third, since the foot pulse is non-saturated linear amplification in the whole amplification chain so its stability is more challenging to control than the main pulse. Excessive power fluctuations in the foot-pulse can degrade the irradiation uniformity during the isentropic compression process of the entire target sphere and affect the mismatch of timing and strength of the shockwave, thereby reducing the areal density. (See D. H. Froula et al., “Mitigation of cross-beam energy transfer: Implication of two-state focal zooming on OMEGA,” Physics of Plasmas 20, 102704 (2013).) The laser pulse shape in the Double-Cone Ignition (DCI) scheme employs a near-isentropic nanosecond compression waveform, which is used to compress fusion fuel isentropically within two gold cones placed in opposition. Under the constraining effect of the gold cones, the fusion fuel reaches extremely high velocities and densities, and is confined to be ejected from the cone apertures. Subsequently, the plasma ejected from one cone collides with that from the opposing cone, thereby increasing the temperature and density of the fusion fuel. Since all beams in the Double-Cone Ignition scheme are constrained by the gold cones to only irradiate the same conical surface, the requirement for power balance between beams can be reduced. The focus is only on the intensity balance of all beams superimposed on the two conical surfaces.

### SUMMARY OF THE INVENTION

To address the shortcomings of the existing technologies, the present invention provides a nanosecond laser spatial-temporal control method and facility for Double-Cone Ignition direct-drive scheme. Assuming that the total number of nanosecond laser pulses on both cones in the Double-Cone Ignition direct-drive scheme is n, for the n/2 laser pulses on a single cone, using a portion of them, i.e., m beams, to generate a low-energy foot pulse focused on a target surface with an initial radius of Rₜ to provide better illumination uniformity, and using the remaining (n/2−m) beams to generate a high-energy main drive pulse focused on a relatively smaller R_{b}(R_{b}=0.7 Rₜ) to mitigate cross-beam energy transfer (CBET) and enhance laser-target coupling efficiency.

The present invention provides a nanosecond laser spatial-temporal control method for Double-Cone Ignition direct-drive laser facility, characterized by redistributing the temporal waveforms of all nanosecond laser pulses in the facility while satisfying the near-isentropic compression waveform required for driving implosion. The method of the present invention comprises the following steps:
using a small portion of the beams to generate a low-energy foot pulse, which is focused on a larger target surface, causing the target surface to slowly contract inward under the action of the low-energy foot pulse; by the end of the low-energy foot pulse duration, the target surface contracts to a smaller target surface;
using the remaining majority of the beams to generate the main drive pulse, which is focused on the smaller target surface, thereby achieving zooming; the duration of the near-isentropic compression waveform for driving implosion is from 0˜τ, the duration of the low-energy foot pulse is from 0˜t_{d}, and the duration of the main drive pulse is from t_{d}˜τ, t_{d} corresponds to the moment when the target capsule converges from its initial radius Rₜ to 0.7 Rₜ; for the n/2 nanosecond laser pulses on a single cone, m beams are used to generate the low-energy foot pulse, which is focused on the target surface with the initial radius Rₜ. The energy of the low-energy foot pulse is converted into the kinetic energy of the target shell, causing the target surface with the initial radius Rₜ to slowly contract inward; when the target surface converges to a smaller radius R_{b}(R_{b}−0.7 Rₜ) at time t_{d}, the high-energy main drive pulse generated by the remaining (n/2−m) beams begins to act, focusing on the target surface with radius Rb, thereby achieving zooming;
wherein, the low-energy foot pulse refers to the time-power curve corresponding to the reduction of the target capsule radius from the initial radius Rₜ to 0.7 Rₜ, while the high-energy main drive pulse refers to the time-power curve corresponding to the further reduction of the target capsule radius from 0.7 Rₜ (Research has shown that the optimal zoom position satisfies R_{b}/Rₜ=0.7, which can further increase the implosion velocity).

In the present invention, the requirements for the m nanosecond laser pulses generating the low-energy foot pulse are as follows:
(1) ensure that each nanosecond laser pulse is within a safe energy density of 4 J/cm² to guarantee the reliable operation of the facility;
(2) ensure that the load of the m nanosecond laser pulses generating the low-energy foot pulse is comparable to that of the (n/2−m) nanosecond laser pulses generating the high-energy main drive pulse;
(3) arrange the m nanosecond laser pulses generating the low-energy foot pulse as close as possible to the polar axis to improve the irradiation uniformity of the driving laser on the target surface in the early stage.

The apparatus for implementing the above-mentioned nanosecond laser spatial-temporal control method for the Double-Cone Ignition direct-drive laser facility of the present invention comprises, in sequence along the direction of the front-end seed source transmission, a spectral dispersion grating, a transmission amplification component, a frequency-doubling and tripling crystal, a continuous phase plate, a polarization control plate, a focusing lens, and a target surface. The seed light output from the front-end seed source enters the transmission amplification component after passing through the spectral dispersion grating for beam aperture and energy amplification. It is then converted from the fundamental frequency to the third harmonic by the frequency-doubling and tripling crystal. The continuous phase plate shapes the far-field focal spot into a spot with a certain shape and size. After passing through the polarization control plate, the focusing lens focuses the light on the far-field target surface to form a shaped focal spot. After passing through the spectral dispersion grating, the continuous phase plate, the polarization control plate, and the focusing lens, the far-field light field distribution of each nanosecond laser pulse on the target surface can be represented as:

$${E}_{fj} ( {x}_{f} , {y}_{f} , t ) = \frac{exp ( i {k}_{3 ω j} 2 f )}{i {λ}_{3 ω j} f} FT \{ {E}_{j} exp [ i ( {φ}_{CPP} + {φ}_{SSD - j} ) ] \} , \qquad ( 1 )$$

wherein

$${E}_{j} = exp [ - ( \frac{{x}^{2 N}}{{w}_{0}^{2 N}} + \frac{{y}^{2 N}}{{w}_{0}^{2 N}} ) ] exp ( i {φ}_{random} ) exp ( i {ω}_{3 ω j} t )$$

is the near-field distribution of each nanosecond laser pulse, λ_{3ωj}, k_{3ωj}; and ω_{3ωj}; are the center wavelength, wave vector, and frequency corresponding to each nanosecond laser pulse, respectively, φ_{CPP} and φ_{SSD} are the phase modulations of the beam by the continuous phase plate and the spectral dispersion grating, respectively, f is the focal length of the focusing lens, “FT” denotes the Fourier transform, φ_{random} represents the random phase distortion introduced during the beam propagation, which can be expressed as:

$$( 2 )$$

$${φ}_{random} ( x , y ) = {σ}_{l} random ( - 1 , 1 ) ⊗ exp [ - ( \frac{{x}^{2}}{{g}_{x}^{2}} + \frac{{y}^{2}}{{g}_{γ}^{2}} ) ] + {σ}_{h} random ( - 1 , 1 )$$

over the integration time Δt, the far-field light intensity distribution is given by:

$$I = \frac{1}{Δ t} {\int }_{0}^{Δ t} ( {\vert {E}_{fx} \vert}^{2} + {\vert {E}_{b} \vert}^{2} ) dt , \qquad ( 3 )$$

wherein, Δt is the integration time.

In the present invention, each nanosecond laser pulse is generated by a different front-end seed source, thereby enabling independent control of the temporal and spectral characteristics of each beam.

Further, the seed laser can be tuned in terms of center wavelength.

Further, the temporal pulse shaping unit can achieve precise control of the temporal-power profile, thereby enabling high-precision control of the timing of each nanosecond laser pulse and high-precision adjustment of the time delay, with a control accuracy at the picosecond level.

Further, the phase modulation unit can control the spectrum.

Further, the combination of the spectral dispersion grating and the phase modulation unit in the front-end seed source can produce a time-varying speckle structure, thereby smoothing the focal spot over a specific period of time.

Further, the continuous phase plates used for each nanosecond laser pulse during propagation have different target focal spot sizes. For the low-energy foot pulse, the target focal spot size is slightly smaller than the initial target surface with radius Rₜ to provide better illumination uniformity. For the high-energy main drive pulse, the target focal spot size is slightly smaller than the target surface with radius R_{b} to reduce cross-beam energy transfer (CBET) and improve laser-target coupling efficiency.

Further, the polarization state of the polarization control plate can be linearly polarized light along the tangent or normal direction of the position on the ring where the beam is located for different nanosecond laser pulses, or it can be left-hand or right-hand circularly polarized light, or elliptically polarized light, with the aim of reducing the correlation between the sub-beams.

Further, the target positions for the m low-energy foot pulses and the (n−m) high-energy main drive pulses are different. The target positions for the (n−m) high-energy main drive pulses are slightly offset to the back.

The advantages of the present invention are as follows:
1. The present invention is the first to provide a nanosecond laser spatial-temporal control method for a Double-Cone Ignition direct-drive laser facility. By using a small number of beams to generate a low-energy foot pulse focused on the target surface with the initial radius to provide better illumination uniformity, and using the remaining majority of beams to generate a high-energy main drive pulse focused on a relatively smaller target surface to reduce cross-beam energy transfer and improve laser-target coupling efficiency.
2. The zoom control described in the present invention is achieved by using a small number of beams to generate the low-energy foot pulse. This reduces the impact of front-end system electrical noise on waveform stability at low power levels, while also increasing the gain saturation of the main amplifier chain and stability of second and third harmonic conversion efficiency. Overall, this improves the stability and control accuracy of the foot pulse, effectively enhances the control precision of the time-power profile irradiated on the target surface, and better controls the timing and intensity matching of the shock waves.

### BRIEF DESCRIPTION OF THE DRAWINGS

FIG. 1A shows the baseline time-power curve for the Double-Cone Ignition direct-drive laser facility described in the present invention; FIG. 1B illustrates the time-power curves for a single foot pulse and a single main drive pulse using the “4 foot pulses+12 main pulses” zooming scheme. The vertical axis in both figures represents P(TW).

FIG. 2 depicts the beam arrangement on a single cone of the Double-Cone Ignition direct-drive laser facility in the present invention.

FIG. 3 presents the optical path of each nanosecond laser pulse during transmission in the Double-Cone Ignition direct-drive laser facility of the present invention.

FIGS. 4A and 4B show the variation of irradiation uniformity on the target surface with integration time for the 4 foot pulse and 12 main pulses in the Double-Cone Ignition direct-drive laser facility of the present invention. The vertical axis in both figures represents c.

FIGS. 5A and 5B illustrate the irradiation results on the target surface at an integration time of 100 ps in the Double-Cone Ignition direct-drive laser facility of the present invention, where FIG. 5A shows the irradiation result of the 4 foot pulses on the target surface with the initial radius of the target capsule, and FIG. 5B shows the irradiation result of the 12 main drive pulses on the target surface with 0.7 times the initial radius of the target capsule. The vertical axis in both figures represents y/μm.

FIG. 6 shows the time-power curves for a single foot pulse and a single main drive pulse using the “2 foot pulses+14 main pulses” zooming scheme in the Double-Cone Ignition direct-drive laser facility of the present invention. The vertical axis represents P(TW).

FIGS. 7A and 7B illustrate the irradiation results on the target surface at an integration time of 100 ps in the Double-Cone Ignition direct-drive laser facility of the present invention, where FIG. 7A shows the irradiation result of the 2 foot pulses on the target surface with the initial radius of the target capsule, and FIG. 7B shows the irradiation result of the 14 main drive pulses on the target surface with 0.7 times the initial radius of the target capsule. The vertical axis in both figures represents y/μm.

The reference numbers in the figures represent the following structures: 1—Front-end seed source; 2—Spectral dispersion grating; 3—Transmission amplification component; 4—Frequency-doubling and tripling crystal; 5—Continuous phase plate; 6—Polarization control plate; 7—Focusing lens; 8—Target surface; 11—Seed laser; 12—Temporal pulse shaping unit; 13—Phase modulation unit.

### DETAILED DESCRIPTION OF THE INVENTION

The following detailed description of the invention is provided in conjunction with the accompanying drawings. It is necessary to point out that the described embodiments are used to further describe the invention and do not limit the scope of protection of the invention.

### Example 1

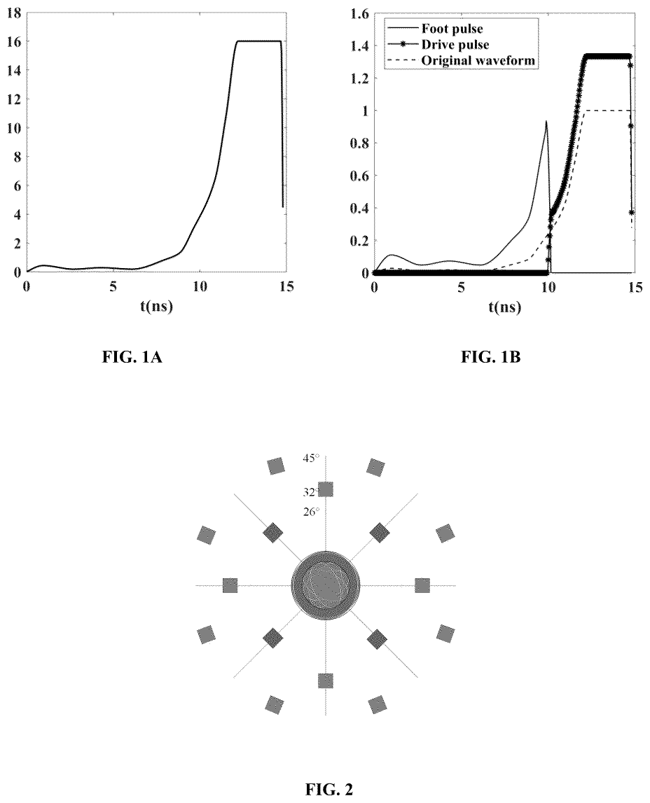

This example primarily considers the physical requirements for compressing the target capsule in the Double-Cone Ignition direct-drive laser facility described in the present invention. It provides the physical basis for the “4 foot pulses+12 main pulses” zooming scheme design based on the Double-Cone Ignition direct-drive laser facility. The beam aperture is 375 mm×375 mm. The baseline time-power curve for the Double-Cone Ignition direct-drive laser facility requiring irradiation on a single cone is shown in FIG. 1A. This curve is evenly distributed among 16 nanosecond laser pulses. The contrast of the baseline time-power curve on a single path is 55:1, with a peak power density of 711 MW/cm² and an energy density of 2.97 J/cm².

To improve the control precision of the foot pulse and maximize the output capability of the facility, 4 beams are used to generate only the foot pulse, with a duration of 0-10 ns and a total energy of 6.20 kJ. The remaining 12 beams are used to generate only the main drive pulse, with a duration of 10-15 ns and a total energy of 60.54 kJ. The sum of these 16 nanosecond laser pulses meets the baseline time-power curve for irradiation on a single cone.

Thus, the contrast of a single foot pulse is 13:1, with a peak power density of 666 MW/cm₂ and an energy density of 1.16 J/cm². The contrast of a single main drive pulse is 3.7:1, with a peak power density of 948 MW/cm² and an energy density of 3.57 J/cm². The time-power curves of the single foot pulse and single main drive pulse are shown in FIG. 1B. Compared with the baseline time-power curve, the waveform contrast is significantly reduced, thereby effectively improving pulse stability.

Since the 12 main drive pulses begin 10 ns after the 4 prepulses, these 12 main drive pulses use a small focal spot CPP (Continuous Phase Plate), while the other 4 foot pulses use a large focal spot CPP to achieve the zooming scheme.

Referring to FIG. 2, which shows the beam arrangement on a single cone of the Double-Cone Ignition direct-drive laser facility.

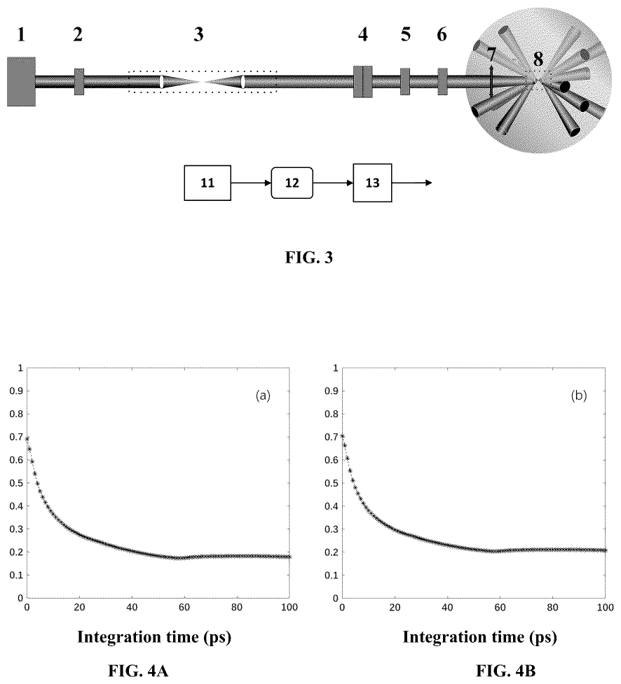

Referring to FIG. 3, which first considers the irradiation uniformity of the 4 foot pulses on the large focal spot in the far field. The angle between these 4 foot pulses and the polar axis is 26°. Each foot pulse sequentially passes through the front-end seed source (1), spectral dispersion grating (2), transmission amplification component (3), frequency-doubling and tripling crystal (4), continuous phase plate (5), polarization control plate (6), focusing lens (7), and target surface (8) during generation, transmission, and focusing.

The relevant parameters of the spectral dispersion grating (2) are as follows: temporal phase modulation frequency. fₘ=17 GHz, modulation depth m=2.4, grating dispersion coefficient δθ|δλ=215.68 urad/nm.

The target focal spot of the continuous phase plate (5) is an elliptical focal spot, which is projected onto the target surface as a circular focal spot with a radius slightly less than 1000 μm.

The focal length of the focusing lens (7) is 5 m. The initial radius of the target surface (8) is Rₜ=1000 um. The fundamental frequency center wavelength of each foot pulse is 1053 nm, and the third harmonic center wavelength is 351 nm. The pointing accuracy is 30 μm rms.

To quantitatively analyze the variation of focal spot uniformity with integration time, the flux contrast C of the focal spot is used for evaluation. A smaller flux contrast C indicates better focal spot uniformity. The calculation method for C is as follows:

$$C = \frac{\sqrt{{\sum }_{i} {\sum }_{j} {[ {I}_{i , j} ( {x}_{f} , {y}_{f} ) - {I}_{mean} ( {x}_{f} , {y}_{f} ) ]}^{2} / {N}_{x} {N}_{y}}}{{I}_{mean} ( {x}_{f} , {y}_{f} )} \qquad ( 4 )$$

Wherein, I_{i,j}(x_{f}, y_{f}) at the focal plane (x_{f}, y_{f}) intensity at the location, Iₘₑₐₙ(x_{f}, y_{f}) the average intensity at the focal plane.

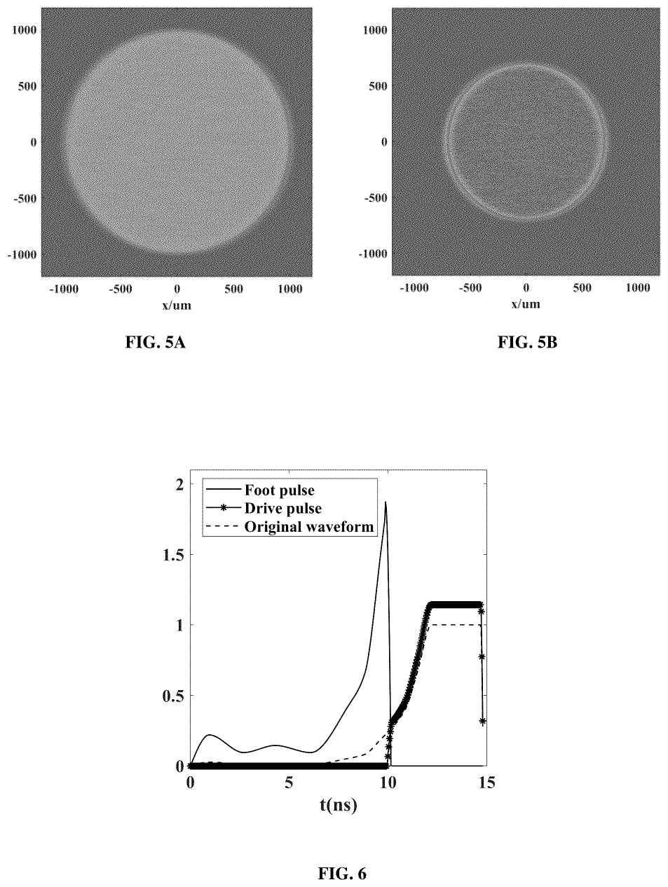

When quantitatively analyzing the focal spot uniformity, the flux contrast of the focal spot is calculated for the region with an 80% encircled energy ratio, as shown in FIGS. 4A and 4B. FIG. 4A shows the variation of irradiation uniformity on the target surface 8 with integration time for the 4 foot pulses. At an integration time of 100 ps, the irradiation uniformity is 0.1740, and the irradiation situation on the target surface is shown in FIG. 5A.

Similarly, the irradiation situation of the 12 main drive pulses on the smaller focal spot is considered. These 12 main drive pulses comprise 4 beams with an angle of 32° to the polar axis and 8 beams with an angle of 45° to the polar axis.

For these 12 main drive pulses, the radius of the target surface 8 is 0.7 Rₜ. The variation of the flux contrast of the focal spot within the region of the 80% encircled energy ratio with integration time is shown in FIG. 4B. At an integration time of 100 ps, the irradiation uniformity is 0.2072, and the irradiation situation on the target surface is shown in FIG. 5B.

### Example 2

This example primarily considers the physical basis for the “2 foot pulses+14 main pulses” zooming scheme design based on the Double-Cone Ignition direct-drive laser facility. The beam aperture is 375 mm×375 mm. The time-power curves of the single foot pulse and single main drive pulse obtained through this division method are shown in FIG. 6.

In this way, the peak power density allocated to a single foot pulse is 1332 MW/cm², and the energy density of the single foot pulse is 2.32 J/cm²; the peak power density allocated to a single main drive pulse is 812 MW/cm², and the energy density of the single main drive pulse is 3.06 J/cm².

In this zooming scheme, two adjacent prepulses from the 4 foot pulses described in Example 1 are selected as the two foot pulses for Example 2, acting on the target surface with radius Rₜ.

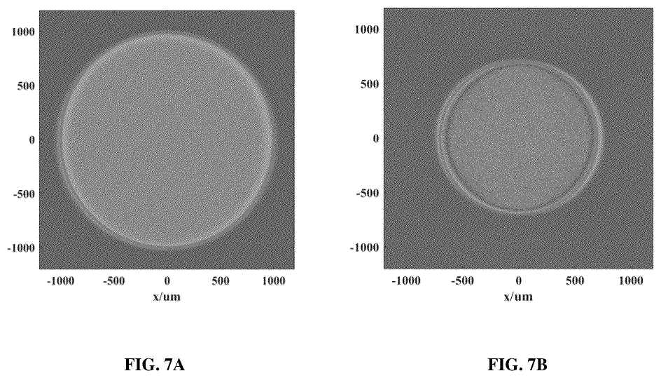

The uniformity of the focal spot is then quantitatively analyzed. At an integration time of 100 ps, the flux contrast is calculated for the region within the 80% encircled energy ratio of the focal spot, resulting in a value of 0.1157. The irradiation situation on the target surface is shown in FIG. 7A.

Similarly, the irradiation situation of the remaining 14 main drive pulses on the smaller focal spot is considered. The radius of the target surface 8 is 0.7 Rₜ. At an integration time of 100 ps, the flux contrast of the focal spot within the 80% encircled energy ratio region is 0.2117. The irradiation situation on the target surface is shown in FIG. 7B.

Compared with Example 1, although the irradiation uniformity on the larger focal spot using 2 foot pulses in Example 2 is better (this is because the two beams can have their polarization directions controlled to be mutually perpendicular, resulting in incoherent superposition on the target surface), the peak power density on a single foot pulse in Example 2 is too high, which can easily cause damage to optical components.

The above-described embodiments are merely preferred embodiments of the present invention and are not intended to limit the invention. For those skilled in the art, the invention can also be subject to various modifications and variations.

The method of the present invention, through the redistribution of the time-power curves of all sub-beams, reduces the waveform contrast of the sub-beams, allowing for higher precision control of the time-power curve on the target surface. It also effectively mitigates the energy loss caused by cross-beam energy transfer (CBET) and improves the laser-target coupling efficiency. Additionally, it enhances the irradiation uniformity of the target.

We claim:

1. A nanosecond laser spatial-temporal control method based on a Double-Cone Ignition direct-drive laser facility, comprising:
redistributing time-power curve of all nanosecond laser pulses in the Double-Cone Ignition direct-drive laser facility under a condition of meeting near isentropic compression waveforms for driving implosion;
generating a low-energy foot pulse by using a small part of beams, focusing the low-energy foot pulse on a larger target surface, and enabling the larger target surface to slowly shrink inward under action of the low-energy foot pulse and shrink to a smaller target surface at an end of a duration of the low-energy foot pulse; and
generating a main drive pulse by using most of a remaining beams, and focusing the main drive pulse on the smaller target surface, thereby achieving zooming.

2. The nanosecond laser spatial-temporal control method based on a Double-Cone Ignition direct-drive laser facility according to claim 1, wherein a duration of the near isentropic compression waveforms for driving implosion is 0−τ, the duration of the low-energy foot pulse is 0−t_{d}, a duration of the main drive pulse is t_{d}−τ, and t_{d} corresponds to a corresponding moment when a target pellet converges from an initial radius Rₜ to 0.7 Rₜ.

3. The nanosecond laser spatial-temporal control method based on a Double-Cone Ignition direct-drive laser facility according to claim 1, wherein a number of the all nanosecond laser pulses in the Double-Cone Ignition direct-drive laser facility is n beams; and then, in the case of ensuring a balance of intensity of a power sum of n/2 beams of nanosecond laser pulses on upper and lower cones, a time waveform of each beam is redesigned so that a sum of the n/2 beams of the nanosecond laser pulses satisfies the near isentropic compression waveforms for driving implosion.

4. The nanosecond laser spatial-temporal control method based on a Double-Cone Ignition direct-drive laser facility according to claim 1, wherein, for n/2 beams of nanosecond laser pulses on a single cone, the low-energy foot pulse is generated by using a small portion of beams that are m beams and focused on a larger target surface;
on a target surface with an initial radius of Rₜ, the energy of the low-energy foot pulse is converted into kinetic energy of a target shell, and the target surface with the initial radius of Rₜ slowly shrinks inward; and
when the target surface converges to a smaller target surface with a target surface radius of R_{b} at a moment t_{d}, R_{b}/Rₜ=0.7, and (n/2−m) beams are left, that is, a high-energy main drive pulse generated by most of the remaining beams is focused on the target surface with the radius of R_{b}, thereby achieving zooming.

5. The nanosecond laser spatial-temporal control method based on a Double-Cone Ignition direct-drive laser facility according to claim 1, wherein m beams of nanosecond laser pulses for generating the low-energy foot pulse should satisfy the following conditions:
each nanosecond laser pulse is within a safe energy density of 4 J/cm²;
a load of m beams of nanosecond laser pulses for generating the low-energy foot pulse is equal to a load of (n/2−m) beams of nanosecond laser pulses for generating the high-energy main drive pulse; and
the m beams of nanosecond laser pulses for generating the low-energy foot pulse are arranged as much as possible on a ring with an smallest comprised angle to a polar axis to improve the irradiation uniformity of drive laser at an early stage on the target surface.

6. A facility for implementing the nanosecond laser spatial-temporal control method based on a Double-Cone Ignition direct-drive laser facility according to claim 1, comprising:
a spectral dispersion grating (2),
a transmission amplification assembly (3),
a frequency-doubling and tripling crystal (4),
a continuous phase plate (5),
a polarization control plate (6),
a focus lens (7), and
a target surface (8),
wherein the spectral dispersion grating (2), the transmission amplification assembly (3), the frequency-doubling and tripling crystal (4), the continuous phase plate (5), the polarization control plate (6), the focus lens (7), and the target surface (8) are sequentially arranged along a transmission direction of a front-end seed source (1), a seed light output from the front-end seed source (1) enters the transmission amplification assembly (3) after passing through the spectral dispersion grating (2) to amplify a beam diameter and energy; fundamental frequency light is converted into triple frequency light through the frequency multiplication crystal (4); and
a far-field focal spot is shaped into a focal spot of a specified shape and size through the continuous phase plate (5), passes through the polarization control plate (6), and is then focused by the focusing lens (7) on the far-field target surface (8) to form a shaped focal spot.

7. The facility according to claim 6, wherein n beams of nanosecond laser pulses are generated by different front-end seed sources (1), so that the time and frequency domain characteristics of each light beam can be independently controlled.

8. The facility according to claim 6, wherein the front-end seed source (1) comprises:
a seed light source laser (11),
a time pulse shaping unit (12), and
a phase modulation unit (13),
wherein the seed light source laser (11), the time pulse shaping unit (12), and the phase modulation unit (13) are placed in sequence on the same optical axis,
the seed light source laser (11) is configured to tune a central wavelength;
the time pulse shaping unit (12) is configured to accurately control a time-power curve, thereby achieving high-precision control of the generation time for each beam of nanosecond laser pulse and a high-precision time delay adjustment capability, wherein the control precision is at a picosecond scale; and
the phase modulation unit (13) is configured to control a spectrum.

9. The facility according to claim 8, wherein a speckle structure that varies over time is obtained by combining the spectral dispersion grating (2) with the phase modulation unit (13) in the front-end seed source (1), thereby smoothing a focal spot evenly within a specific time.

10. The facility according to claim 8, wherein a target focal spot of each beam of nanosecond laser pulse on the continuous phase plate (5) used during transmission has a different size; for a low-energy foot pulse, the target focal spot has a size slightly smaller than that of a target surface with an initial radius of Rₜ to provide better illumination uniformity; and for a high-energy main drive pulse, the target focal spot has a size slightly smaller than a target surface with a radius of R_{b} to reduce the energy transfer of crossed light beams and improve the laser-target coupling efficiency.

11. The facility according to claim 8, wherein, for different nanosecond laser pulses, a polarized state of the polarization control plate (6) may be linearly polarized light along a tangent or normal direction of a position on a ring where the light beam is located, or left-handed or right-handed circularly polarized light, or elliptically polarized light, thereby reducing the correlation between sub-beams.

12. The facility according to claim 8, wherein the target surfaces (8) of the m beams of low-energy foot pulses and (n−m) beams of high-energy main drive pulses are different in position, and the target surfaces (8) of the (n−m) beams of high-energy main drive pulses are positioned slightly behind.
